(19) United States
(12) Patent Application Publication
(10) Pub. No.: US 2013/0001224 A1
(43) Pub. Date: Jan. 3, 2013

(54) STORAGE TANK

(76) Inventor: ALTON PAYNE, WINDSOR JUNCTION (CA)

(21) Appl. No.: 13/535,608

(22) Filed: Jun. 28, 2012

(30) Foreign Application Priority Data
Jun. 28, 2011 (CA) 2744682
Feb. 24, 2012 (CA) 2769193

(51) Int. Cl. B65D 88/10; B23P 11/00; B67D 3/00; B65D 21/02; B65D 88/52; B65D 88/54

(52) U.S. Cl. 220/4.17; 220/4.12; 220/601; 222/564; 220/23.87; 29/428

(57) ABSTRACT

A storage tank is described that can be used for on-site storage of liquids, sludge or solids. Advantageously, the storage tank can be adapted to provide various functionality including a double walled containment system. Further, the storage container may be adapted from an intermodal container and include corner castings of a twist lock mechanism.

### TECHNICAL FIELD

The present disclosure relates to a storage tank, in particular, a storage tank for storing liquids, sludge and solids.

### BACKGROUND

There is often a need to provide temporary storage of liquids, sludge and solids. This is common in various industries including oil and gas exploration, oil and gas production, construction, refining, chemical, manufacturing, and water and sewer. Currently, there are various types of storage tanks that typically range in size between 200 barrels to 450 barrels. Some have axles that allow the tank to be towed to the site requiring storage.

A commonly used tank in the oil and gas industry is a frac tank. A frac tank is a portable storage tank constructed of steel walls with a single rear axle that can be towed behind a truck or tractor. However, frac tanks are limited to onsite storage of liquids and are limited in transportation options. The same can be said about other types of storage tanks designed for temporarily storing liquids and sludges.

Intermodal containers are also well known storage and transportation containers used for transporting goods over land and sea. However, they are unsuitable for storing liquids. While storage tanks having the dimensions of a sea container are known, they may be expensive to manufacture and deliver.

Accordingly, a storage tank that addresses some of these deficiencies remains highly desirable.

### SUMMARY

In accordance with the current disclosure, there is provided an intermodal container modified for storing liquid, sludge or solid, the modified intermodal container comprising a container comprising a floor and a roof sealingly joined by opposing side walls and opposing end walls, the container defining an interior space for storing the liquid, sludge or solid, wherein the floor, roof, opposing side walls and opposing end walls being made of a rigid material, and at least one of the opposing end walls being removably attached; and a drain bottom inserted into the interior space, the drain bottom having an open end for receiving the liquid, sludge or solid and a tapered end connected to a drain hole through a pipe assembly, wherein the drain hole is located on the container.

In accordance with the current disclosure, there is further provided a method of creating a sea container modified for storing liquid, sludge or solid, the method comprising: providing a sea container having a floor made of a rigid material and the sea container being hermetically sealed; inserting a drain bottom into an interior space of the sea container through an access door located at an end of the sea container; connecting a tapered end of the drain bottom to a drain hole through a pipe assembly; and removably attaching an end wall to the end of the sea container having the access door.

In accordance with the current disclosure, there is further provided a portable storage tank comprising: an outer sealable container conforming to an ISO intermodal container standard including at least one sealable door; and an inner sealable container sized to be fully received within the outer container including at least one sealable opening through which the inner sealable container can be emptied.

### BRIEF DESCRIPTION OF THE DRAWINGS

Further features and advantages of the present technology will become apparent from the following detailed description, taken in combination with the appended drawings, in which:

FIG. 1 depicts a perspective view of an intermodal container with closed doors;

FIG. 2 depicts a perspective view of the intermodal container with the doors open;

FIG. 3 depicts a perspective view of inserting a drain bottom into the intermodal container;

FIG. 4 depicts the storage tank with a drain bottom inserted;

FIG. 5 depicts a perspective view of an intermodal container and a drain bottom being inserted;

FIG. 6 depicts storage tank with a drain bottom inserted into the intermodal container;

FIG. 7 illustrates a perspective view of a storage tank frame;

FIG. 8 illustrates a front perspective view of a storage tank with an end plate;

FIG. 9 illustrates a front perspective view of a storage tank with a further end plate;

FIG. 10 illustrates variations of manway covers for a storage tank;

FIG. 11 illustrates a secondary containment wall inserted into a storage tank;

FIG. 12 illustrates a top view of a storage tank;

FIG. 13 illustrates a further top view of a storage tank;

FIG. 14 depicts a perspective view of a further embodiment of a storage tank;

FIG. 15 depicts a perspective view of a further embodiment of a storage tank;

FIG. 16 depicts a side view of the storage tank of FIG. 15;

FIG. 17 depicts a section view along the line A-A′ of FIG. 16;

FIG. 18 depicts a detail view along the line B-B′ of FIG. 17;

FIG. 19 illustrates a further illustrative storage tank;

FIG. 20 depicts an interior container of a storage tank;

FIG. 21 depicts a further embodiment of an interior container;

FIG. 22 depicts a side view of the interior container of FIG. 22;

FIG. 23 depicts a front view of the interior container 23;

FIG. 24 depicts a perspective view of an exterior container;

FIG. 25 depicts a front view of the exterior container; and

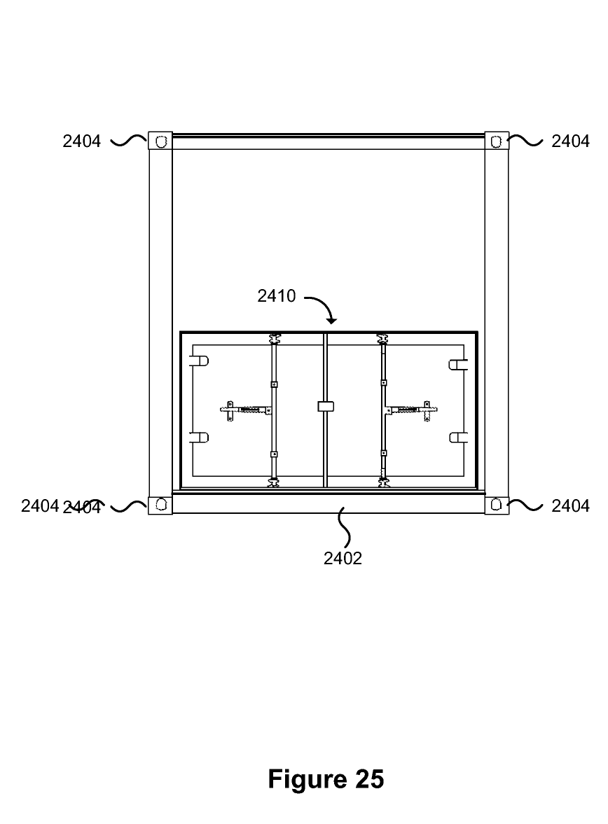

FIG. 26 illustrates a storage tank and adapter.

It will be noted that throughout the appended drawings, like features are identified by like reference numerals.

### DETAILED DESCRIPTION

Intermodal container, also referred to as sea containers, ISO containers and freight containers, have provided a convenient way to efficiently transport goods. The intermodal containers have common dimensions allowing them to be stacked together for transporting. Further, the containers include a common locking mechanism, referred to as a twist-lock, at each corner that allows the containers to be secured together, or secured to a structure or moving equipment such as a crane. In addition to transporting goods, intermodal containers have been adapted to serve a wide range of purposes, such as portable generating stations, portable pumping stations as well as storage or offices.

As described further herein, intermodal containers can be used to provide on-site storage of solids, liquids or sludge. In the oil and gas industry, sites, whether production sites, test sites or exploratory sites, can require different supplies that need to be stored. For example, in fracturing operations, referred to as fracking, large amount of a fracking liquid, typically water with additional chemicals, are required. Sites may also require the storage of solids such as chemicals. Further, waste material from processes may need to be stored on site temporarily, for example to allow solid material to settle out. Sites requiring the storage of liquids, solids or sludges may often be remotely located and as such it may be difficult to transport materials to or from the site. As described further herein, intermodal containers can be used for on-site storage. The standardized dimensions of the containers make transportation convenient. Further, the containers may be easily moved once on-site. Further, the containers can be adapted in various ways depending upon the specific requirements. As will be described further, a container can be readily adapted for storing liquids, such as fracking solution, or solids such as soda ash.

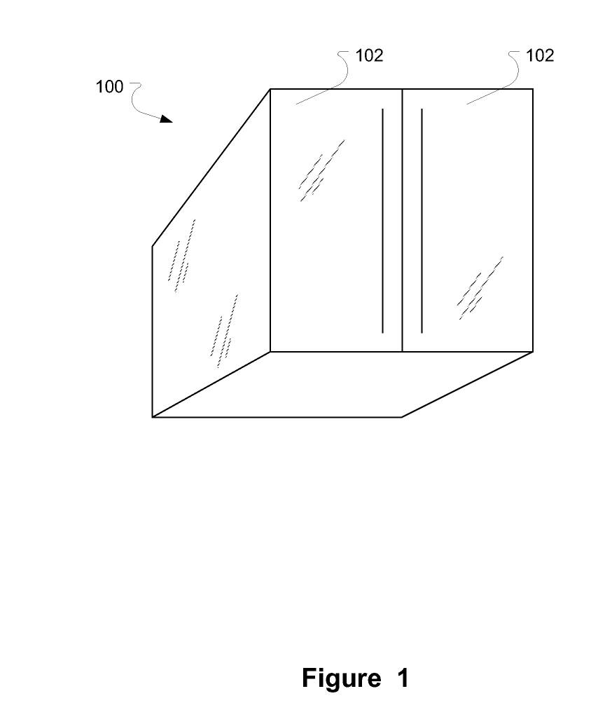

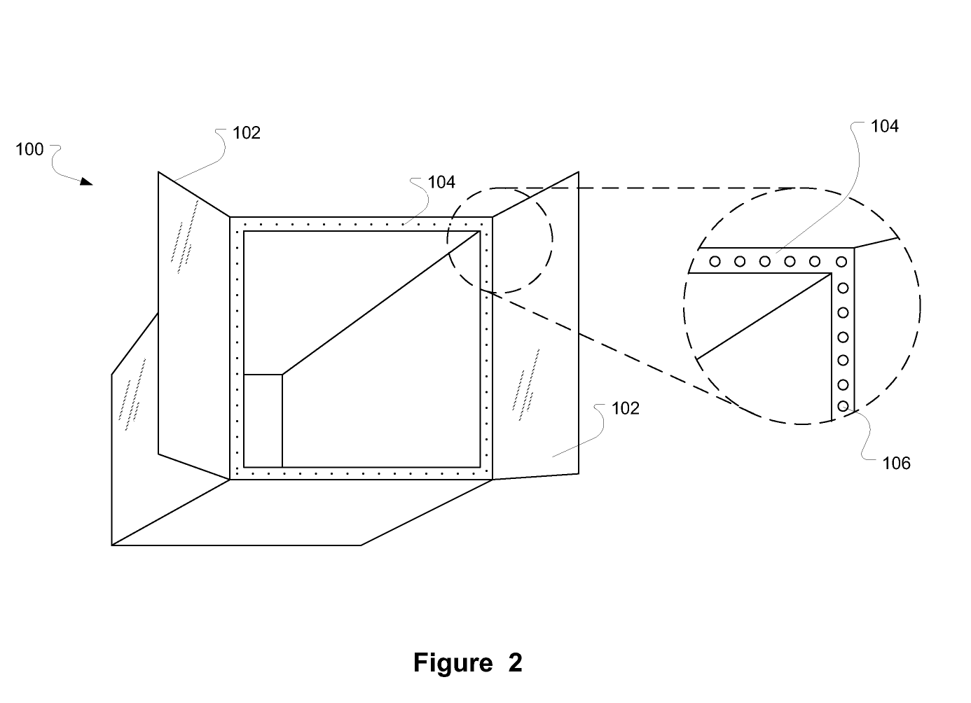

FIGS. 1 and 2 depict an illustrative intermodal container that can be used for storing liquids, solids or sludge. The intermodal container 100 may be a previously used intermodal container and adapted as described, or may be constructed as a new intermodal container incorporating the features described herein. As will be appreciated, there are numerous different standard dimensions for intermodal containers. However, common dimensions are 8′ wide, 8′6″ high and 19′10″ long (referred to as 20 foot containers) or 40′ long (referred to as 40 foot containers).

The container 100 has a pair of access doors 102 on an end of the container. The doors 102 are hinged on the sides and allow access to the interior of the container 100 when opened. The container 100 is depicted as having a single set of access doors 102 on one end of the container. The other end of the container 100 may be a fixed wall or may have an additional set of doors. The additional set of doors may be the full height and width of the container 100, as is the case for doors 102, or be only provide access through an opening in an end wall of the container 100.

The container 100 has a top, bottom, sides, front and back that are constructed so as to provide a sealed compartment when any doors, such as doors 102, are closed and sealed. The walls of the sea container 100, except the access doors 102, can be joined together using a continuous weld.

The storage container described further herein may be produced from used intermodal containers. Goods can be sent in an intermodal container to a destination using typical transportation means such as ships, trains and transport trucks. Once the container 100 reaches the destination, the products may be unloaded by opening the access doors 102 as depicted in FIG. 2. Typically at this time, the unloaded container remains at the destination location until it is reloaded with other goods that require transportation. However, the used container may be converted to use for storing liquids, sludge and solids.

After unloading the goods from the sea container 100, a flange 104 may be attached to the container 100 at the end having the access doors 102. The flange 104 may be welded to the end having the access doors 102. If the container 100 is provided with two sets of access doors, a flange may be attached to each end. The flange 104 can help provide a tight seal when the access doors 102 are closed. Further the flange 104 may be provided with a plurality of bolt holes 106 which may be used to secure further components to the container, such as an end plate.

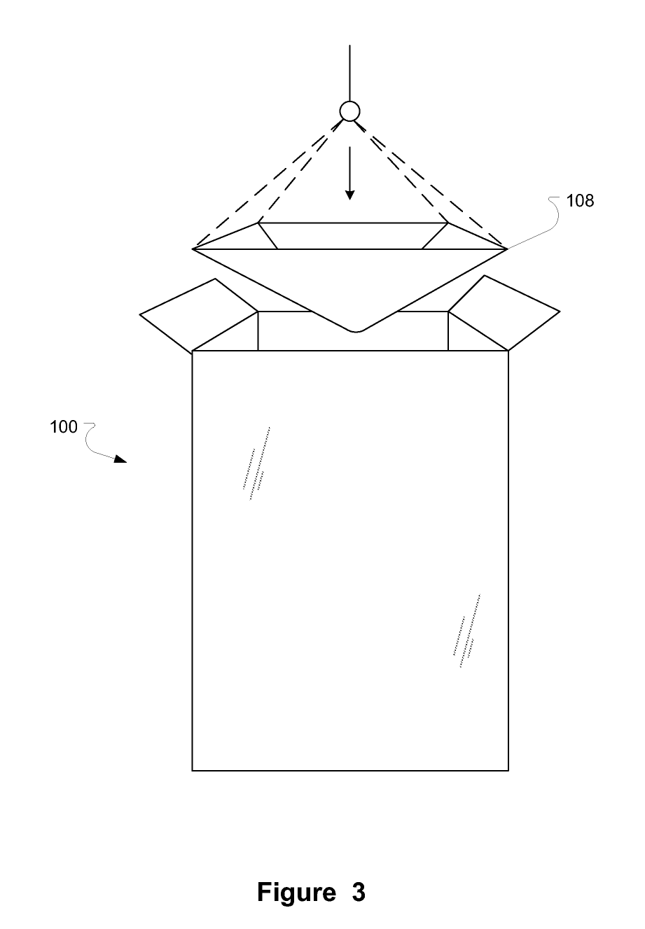

The container 100 can be provided with a drain bottom 108. As depicted in FIG. 3, the container 100 may be arranged vertically and a drain bottom 108 can be lowered into the container 100. In the vertical orientation, the container 100 is positioned such that the end having the access door faces upward so that the drain bottom 108 may be lowered into the container 100. Once the drain bottom 108 is inserted into the container 100, a pipe a pipe assembly no can be attached as shown in FIG. 3. The pipe assembly may be already placed in the container 100 and the drain bottom 108 can then be lowered until an opening in the drain bottom is received over the pipe assembly 110. Alternatively, the pipe assembly no may be attached to the drain bottom before it is lowered in to the container 100.

The drain assembly no may need to be secured to the pipe assembly, for example by welding. In order to accomplish this, an access panel may need to be cut or otherwise provided in order to provide access to the attachment area. Further, the pipe assembly needs to pass through an opening in the container in order to allow the contents of the container 100 to be emptied through the pipe assembly.

With the container 100 in the vertical position, and with the drain bottom 108 located opposite the access doors 102, it is possible to use the access doors 102 when filling the container, either with a liquid, sludge or solids. However, it is also contemplated that one or more access panels or hatches may be provided for filling the container. Further, it may be possible to utilize the pipe assembly to both empty and fill the container 100.

One of the advantages realized in vertically orienting the storage tank 100 is the easier liquid and solid separation. When the storage tank 100 contains fluid that consists of liquid and particles or solids, depending on the properties of the particles or solids, they may settle to the bottom of the liquid over time due to gravity. With a vertically oriented storage tank 100, it is easier to differentiate between the settled particles or solids and liquid. Moreover, the drain bottom facilitates easier removal of solids because of its generally tapered shaped. Further the vertical orientation of the container provides a smaller footprint of the storage tank 100 on site, which may be advantageous in some applications.

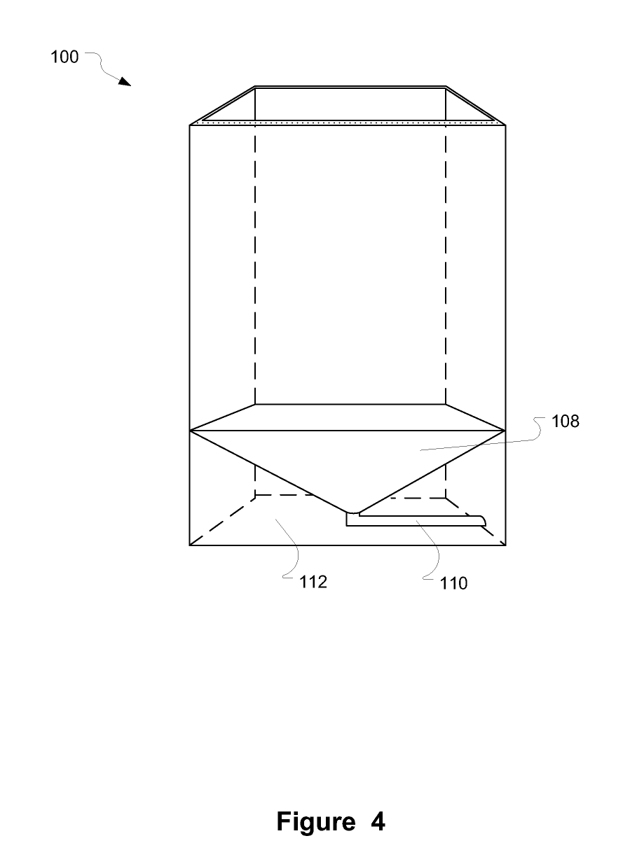

FIGS. 3 and 4 depicted a drain bottom no being lowered into a vertical container. It is possible to provide other drain bottoms, such as drain bottom 200 that can be slid into a container arranged horizontally.

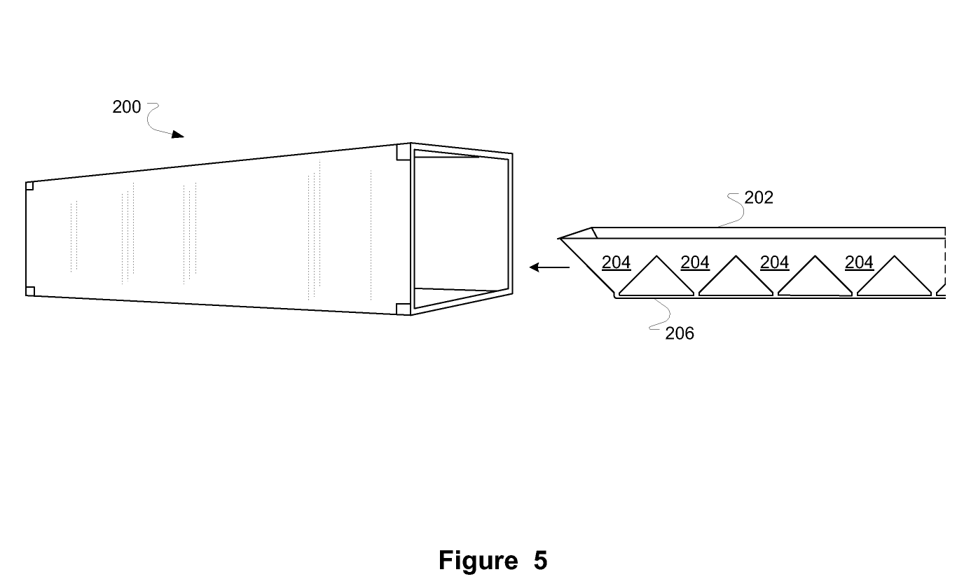

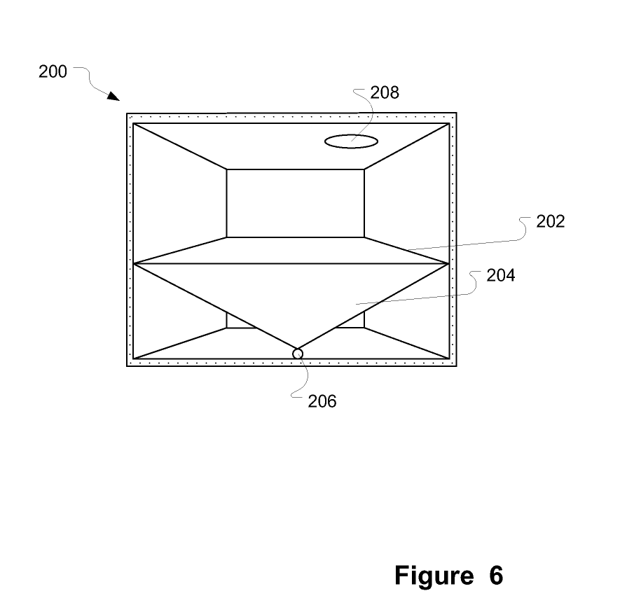

FIGS. 5 and 6 depict a container and a further illustrative drain bottom. The container 200 is similar to the container 100, however is depicted as being a longer container, such as a 40 foot container. The drain bottom 202 is depicted as having multiple tapered bottoms 204 with each connected to a common pipe assembly 206. The drain bottom 204 and pipe assembly 206 may be slid into the container 200 while in a horizontal position as depicted. It is contemplated that the drain bottom 202 may be a single tapered bottom configuration as opposed to the multiple bottoms 204 depicted.

The container 200 may be sealed, either by closing the access doors if a suitable seal is present, or by affixing an end plate to the flange in order to hold liquids, solids or sludge. In contrast to the, vertical arrangement described with regards to FIGS. 3 and 4, it is not possible to fill the container 200 with the access doors open. As such, an access hatch 208, or other means for filling the container, may be provided in the top of the container 200. Additionally or alternatively, the container 200 may be filled through the pipe arrangement 206.

The above containers 100, 200 can hold liquids, sludge or solids. The sloped bottom of the drain bottoms can be useful in emptying solids, such as soda ash, from the containers. The sloped bottoms may also be used when storing liquids. Further, if sludge is to be stored in the container, the sloped portions of the drain bottoms may be perforate to allow liquid to pass through while accumulating suspended solids.

Because the storage tanks 100, 200 are adapted from intermodal containers transporting the storage tank 100, 200 is easily facilitated using existing transport means. For example, the storage tank 100, 200 may be stacked and loaded with other typical intermodal containers on a freight carrier. Moreover, the storage tank 100, 200 may be initially used as an intermodal container to transport goods. Once the goods have been delivered, the container can be adapted to the storage tank 100, 200 as described above to store bulk liquids, solids and/or sludge and transport bulk solids. This allows another entity to bear the transport cost of the container used for the storage tank, which may decrease the cost of manufacturing the storage tanks.

The above has described adapting an existing intermodal container for use in storing liquids, solids or sludge. It is contemplated that the container may be fabricated specifically for the container.

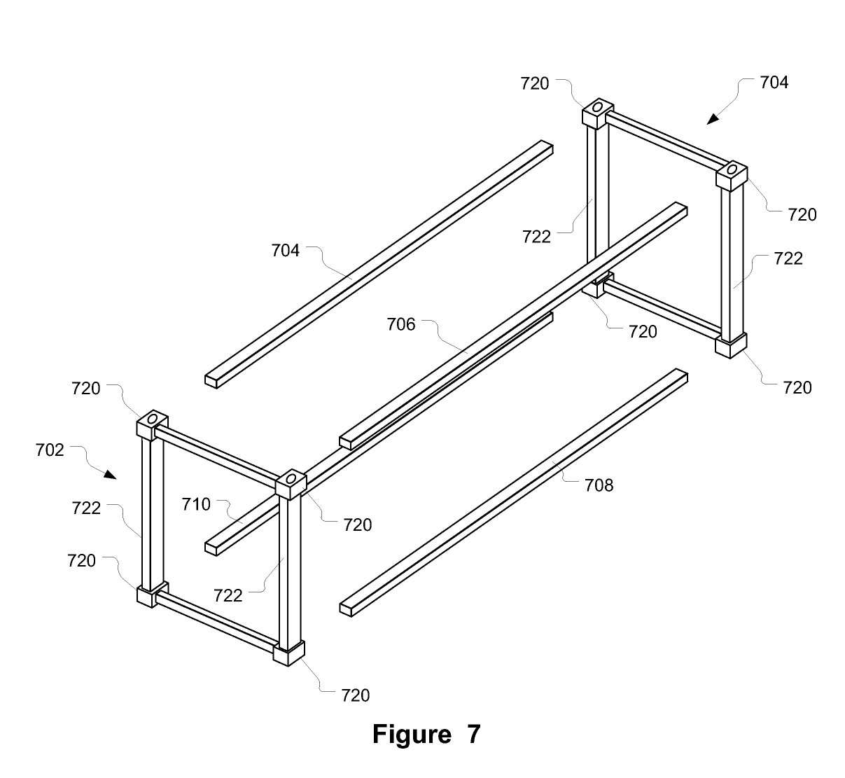

FIG. 7 depicts a frame of a container. When fabricating a container, a frame may be assembled. The frame allows the walls of the container to be attached and provides strength to the final container so that it can hold the weight of the liquid, solid or sludge. The container frame includes opposing end frames 702, 704 connected by side rails 706, 708, 710 and 712. The opposing end frames 702, 704 may provide the flange described above with regards to the containers 100, 200. Although not depicted, additional cross braces or support beams can be added to the frame depending upon the strength required or desired. The additional cross braces or support beams may be attached to one of the opposing end frames 702, 704 or the side rails 708, 710 or both.

The container frame includes a corner castings 720 at each of the eight corners. Each casting forms a female portion of a twist lock that is used to secure the containers to other containers, to structures, or to transportation mechanisms such as cranes.

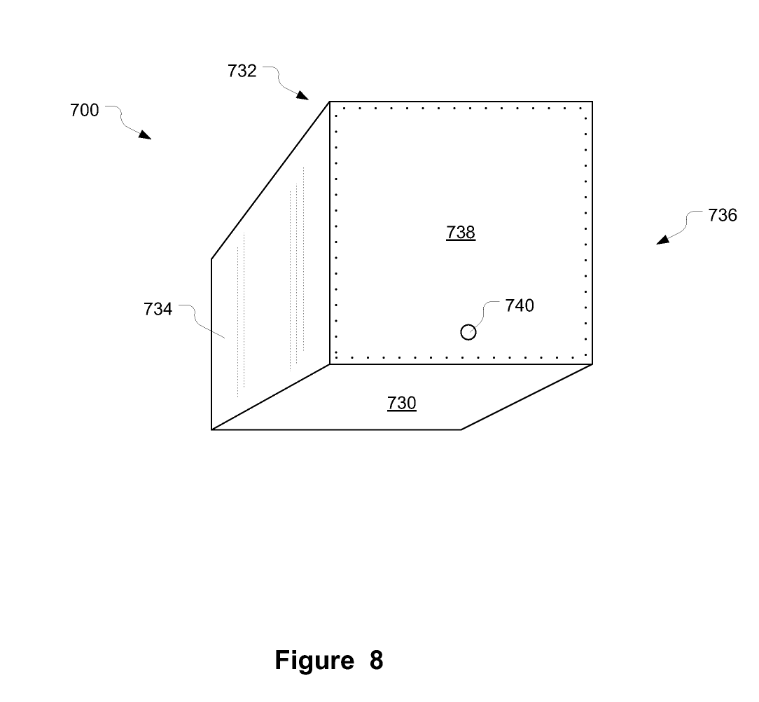

FIG. 8 depicts an assembled container. Once the frame is assembled walls of the container can be assembled. The walls comprise a floor 730 and a roof 732 joined by opposing side walls 734, 736. Access doors may be attached to one end or both ends of the container. Alternatively an end plate 738 may be attached to one or both ends of the container 700. As previously described, the end frames may provide the flange with bolt holes, allowing the end plate 734 to be removeably secured to the end frame. One of the ends of the container 700 may have a fixed end panel, that is a panel that cannot be opened like the doors or removed like the end plate 738.

The floor 730, roof 732, opposing side walls 734, 736 and opposing end walls if present are made of rigid materials such as steel. For example, the rigid material for the floor, roof and opposing side walls may be ¼″ corrugated 50A carbon steel, the frame rails 704, 706 may be 3″×2″, 3/16″ thick Hollow Structural Steel; rails 708, 710 may be 6″ channel made of structural steel at 8.2 lbs/linear foot; additional support beams, if present, may be 4″ channel made of structural steel at 6.2 lbs/linear foot. Each corner post 720 may be 6″×7″ cast steel connected to corner posts 722 of the end frames 702, 704 may be 6″×6″ cast steel to provide sufficient strength for supporting additional containers that are stacked upon it.

As described above, one of the opposing end walls may be a removably attached end plate 738 that can be secured to a flange of the storage tank 700. In one embodiment, the removable end plate 738 may be attached to the flange using bolts through bolt holes. It will be understood that end wall 738 may be removably attached using other removable means known to the person skilled in the art. While the storage tank 700 is considered to have one removably attached end plate that can be used to seal the opening of the container when the access doors are opened, or not present, it is contemplated that both ends of the container 700 may be removably attached. When removably attaching the end plate to the flange, a gasket may be used to ensure a tight seal. As depicted, a drain 740 may be provided in the end plate 738. The drain 740 can be connected to the pipe assembly of the container to allow the container to be drained. The drain 740 may be provided in other locations of the container.

The storage tank 700 may further include a manway on the roof 732 to allow contents to be pumped into the interior space of the storage tank 700. Alternatively, or additionally, contents may be pumped into the storage tank 738 by removing the removable end plate 738 or through a manway on the removal end wall. It will be understood that various other pipe fittings may be added to accommodate the addition and removal of liquids, sludge and solids.

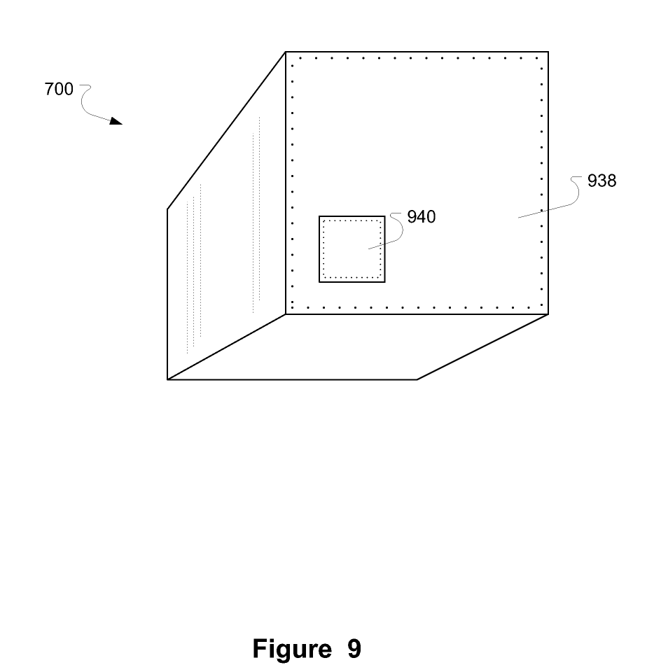

FIG. 9 depicts a further end plate. The end plate 740 may be attached to an end of a container. The end plate is depicted as having a sealable manway 742. The manway provides an opening that can be sealed, for example through a manway cover that can be bolted to the end plate 740. The manway 742 can be used as an entry point for works to inspect the interior of the storage tank. Additionally, the manway may be used to fill the storage tank. Although only a single manway 742 is depicted, it is contemplated that additional manways can be placed on the storage tank. Additionally, the manways can provide a convenient insertion point for different attachments as described below.

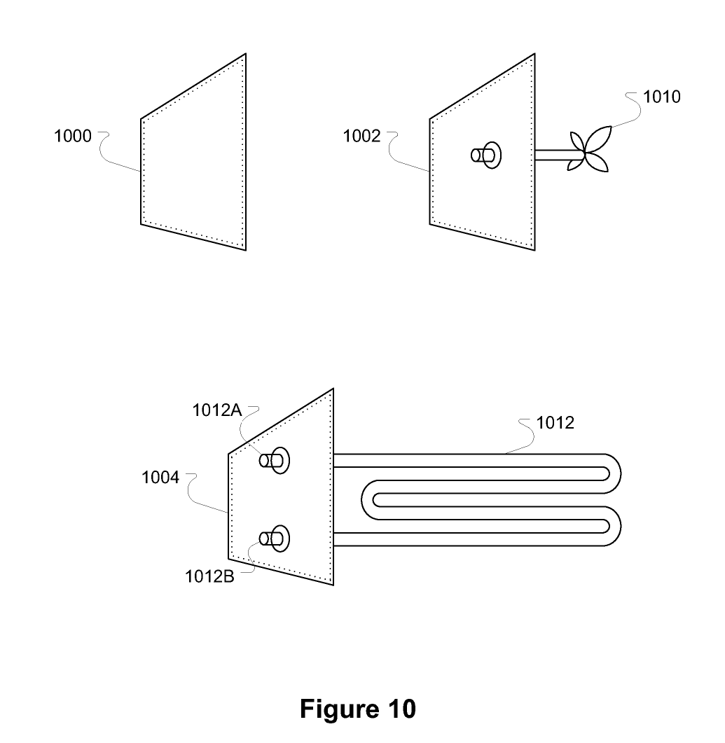

FIG. 10 depicts variations of manway covers. The manway covers 1000, 1002, 1004 depicted may be used to seal a manway opening storage tanks. The different configurations of manway may be on one or more of the walls of the storage tank. For example, one of the manway covers 1000, 1002, 1004 may be on the removable end wall 938 as shown in FIG. 9. In other embodiments, the manway covers 1000, 1002, 1004 may be on the roof of the storage tank. The manway covers may have different configurations as required by the storage tank 100. For example, a mixer 1010 may be mounted to the manway cover 1002. This allows the contents inside the storage tank to be mixed, which may be advantageous when storing sludge, or when storing fracking solution. While the mixer 1010 is shown as a propeller-based mixer, it will be understood that a nozzle-based mixer may also be attached.

In another embodiment, a heating coil 1012 may be provided on the manway cover 1004. The heating coil 1012 may be a steam-based heating coil with the heating steam going into input 1012A and coming out of output 1012B.

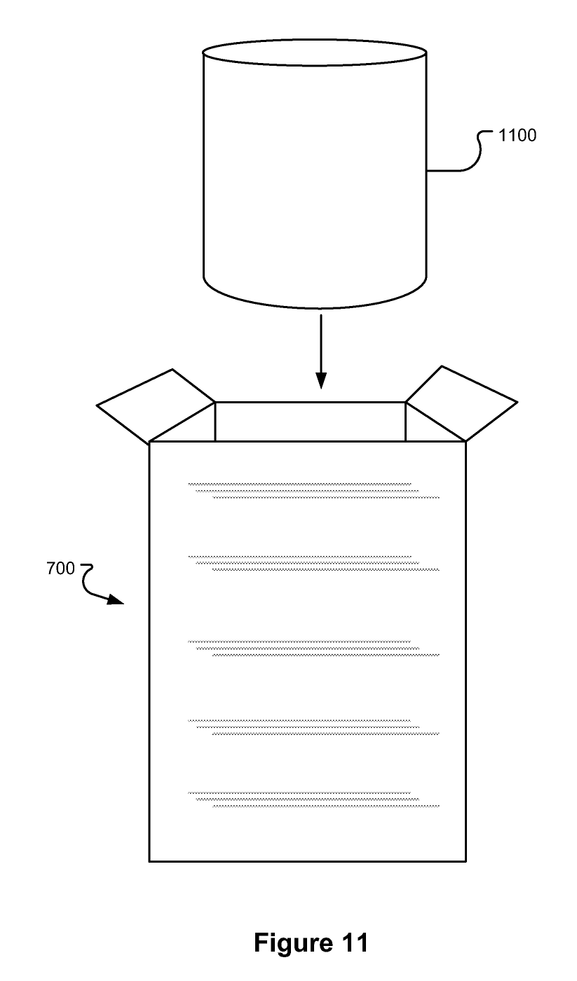

The above has described storage tanks, adapted from a intermodal container, that include a drain bottom inserted into the intermodal container. In some applications, it is desirable to have a double walled container. Double wall containment may be a regulatory requirement for containment of petroleum products or other products. To provide a double wall containment system, a containment wall such as a cylindrical wall 1100 as shown in FIG. 11 may be inserted into the storage tank 700. In this embodiment, the drain bottom to be inserted into the storage tank 700 may be conical in shape so that the edge of the open end is against the cylindrical wall 1100. A seal may be further included to ensure a tight seal against the cylindrical wall 1100. The cylindrical wall 1100 provides a secondary containment wall, while the exterior wall of the container provides a primary containment wall. In another embodiment, the drain bottom may be a different shape having the edge of the open end not entirely against the cylindrical wall 1100. In this embodiment, a seal may be included to close the gap between the edges of the open end of the drain bottom and the cylindrical wall 1100. While the containment wall has been described using a cylindrical wall 1100, it will be understood that walls of other shapes may be contemplated.

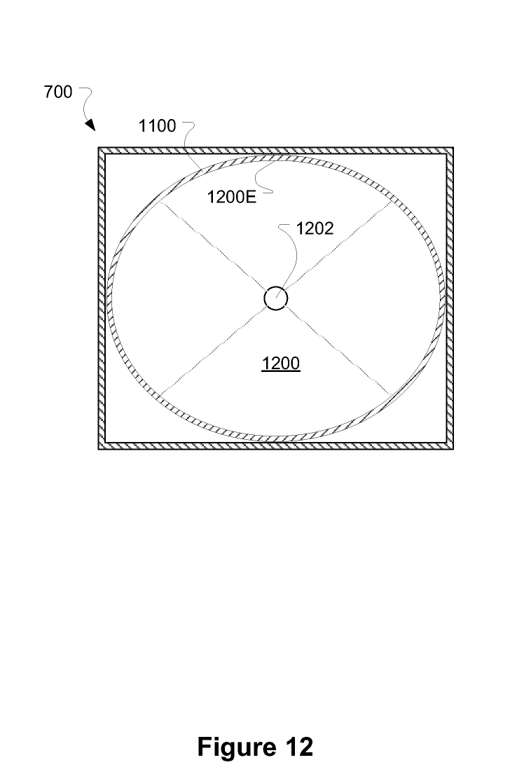

The drain bottom described above is an inverted pyramid. Because the storage tanks are generally in the shape of a rectangular prism, the drain bottoms have an open end that is four sided and a tapered bottom that is connected to the pipe assembly. To ensure that the drain bottom maintains its orientation, the open end of the drain bottom (i.e. the end not connected to the pipe assembly) is dimensioned to be against the walls of the storage tank 100. Referring to FIG. 12, which is a top view of the storage tank, the drain bottom 1200 has four edges 1200A, 1200B, 1200C, and 1200D against the walls of the storage tank 700. When the storage tank 700 is in the horizontal position, the edges of the open end of the drain bottom may be against the opposing side walls and opposing end walls. When the storage tank 700 is in the vertical position, the edges of the open end of the drain bottom may be against the opposing side walls the floor and the roof. Alternatively, or additionally, the drain bottom 1200 may be coupled to the storage tank 700 to further ensure that the orientation of the drain bottom 1200 is maintained. Furthermore, the drain bottom 1200 may incorporate a seal 1210 around the edges of the open end of the drain bottom 1200 to ensure a tight seal between the drain bottom 1200 and the walls of the storage tank 700. FIG. 12 also shows opening 1202 at the bottom of the drain bottom 1200 for draining contents in the storage tank 700 through the pipe assembly.

The above has described inserting a drain bottom 108, 202 that is pyramid-like in shape, it will be understood that the drain bottom 108, 202 may be a different shape. For example, when a cylindrical secondary containment wall is included as described above, the drain bottom may be conical in shape.

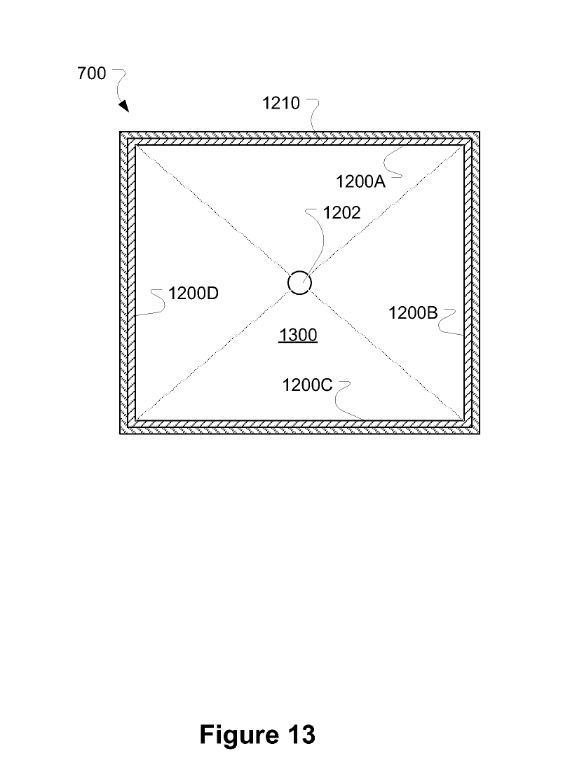

Referring to FIG. 13, which is a top view of a storage tank such as storage tank 700 described above with a cylindrical wall 1100 inserted into the storage tank 700, the edge 1200E of the open end of the drain bottom 1300 may follow the perimeter of the cylindrical wall 1100. As shown in FIG. 13, the edge 1200E may be circular or elliptical in shape depending on the shape of the cylindrical wall 1100. The drain bottom 1300 may be coupled to the storage tank 700 and may further include a seal (e.g. 1210) to ensure a tight seal between the drain bottom 1200 and the walls of the storage tank 700. The drain bottom 1300 of FIG. 13 may also be perforated. It will also be understood that even if there is no cylindrical wall 1100, the drain bottom 1200 may be a shape other than a pyramid or cone such as a shape that is generally tapered at the bottom to allow connection with the pipe assembly. In an embodiment where the edges of the open end of the drain bottom 1300 do not follow the contour of the storage tank 700 or the containment wall (e.g. cylindrical wall 1100), a seal may be used to ensure a tight seal. However, a tight seal between the drain bottom 1300 and the walls of the storage tank 700 is not necessary. Liquid at the bottom of the storage tank (i.e. under the drain bottom) may be beneficial in providing support for the drain bottom 1300.

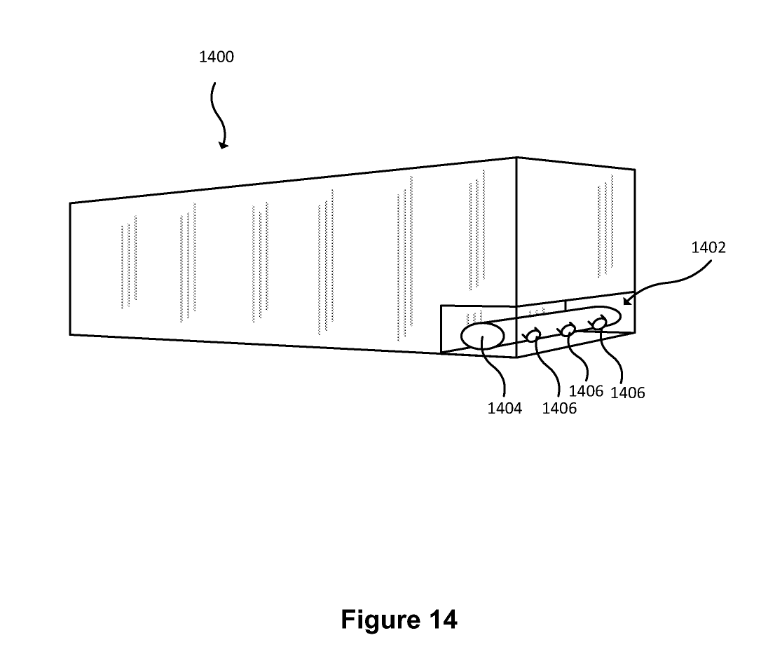

FIG. 14 depicts a further illustrative embodiment of a storage tank. The storage tank 140o may be similar to the storage tanks described above; however, it includes a cut-out portion 1402 in the exterior container. The cut-out portion 1402 allows a manifold 1404 to be mounted to the container while still maintaining the exterior dimensions of the container. The manifold 1404 may comprise a plurality of outlets or inlets 1406 that can be used to fill or empty the storage tank 1400. The manifold 1404 may be connected to manifolds of adjacent storage tanks, allowing multiple storage tanks to be easily connected together. The ends of adjacent manifolds may be connected by an appropriate adapter. When not in use the individual outlets or inlets 1406 can be plugged or otherwise sealed. Similarly, the sides of the manifold may be sealed, for example with a plate, when not connected to other manifolds. The storage tank 1400 may be well suited for use in storing liquids such as frac solution.

The storage tank 1400 may include a drain bottom as described above, with the interior pipe adapter connected to the exterior manifold. If, however the storage tank 1400 is only intended for storing liquids, it may not include a drain bottom. The storage tank 1400 may provide a secondary containment system as described above.

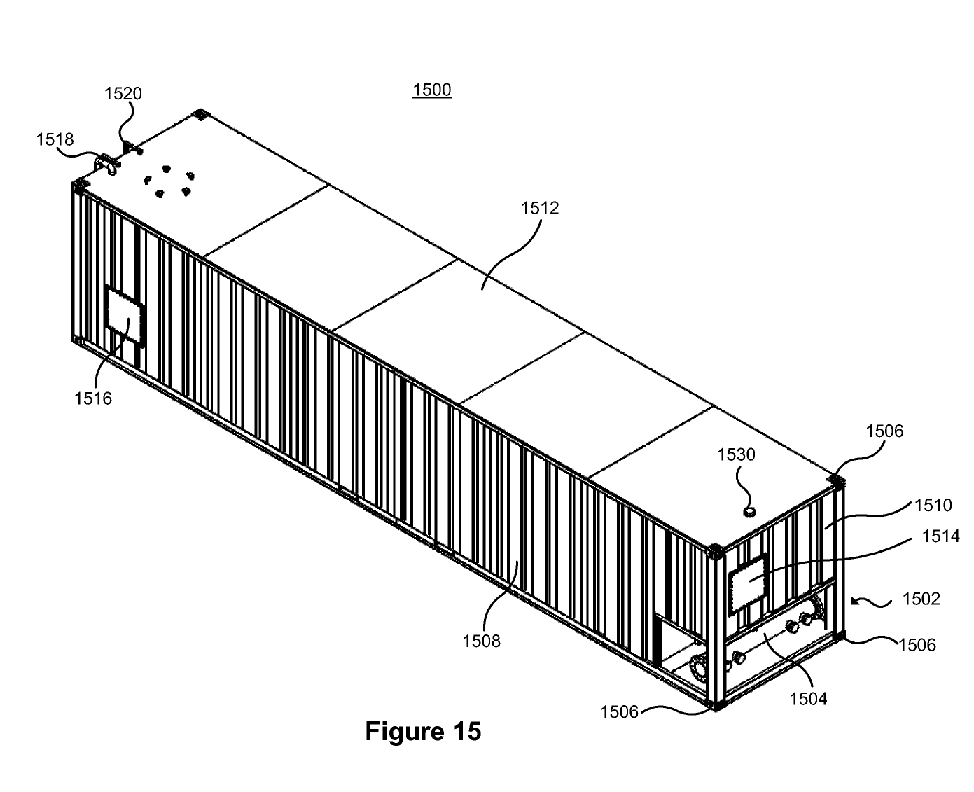

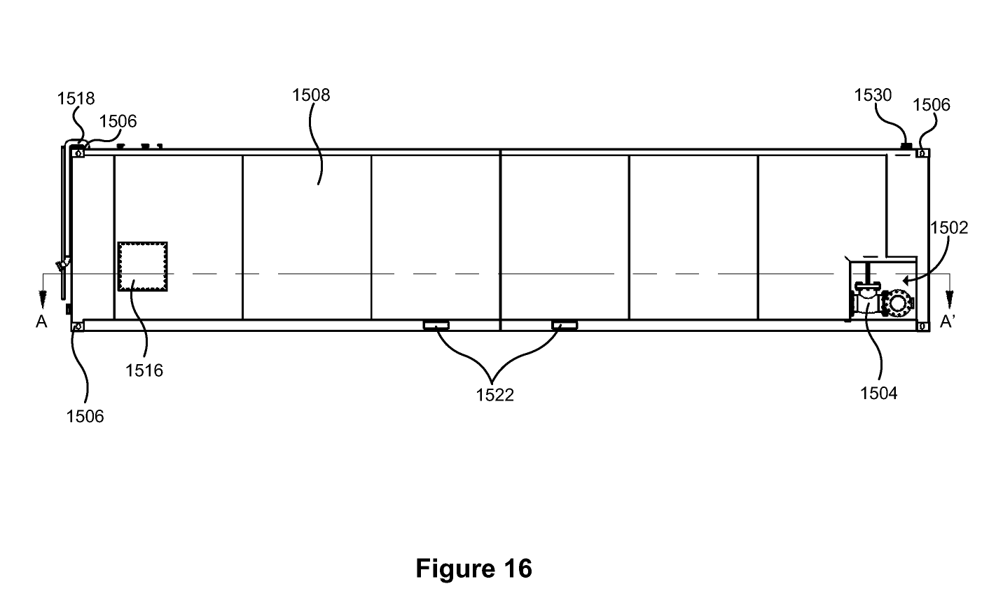

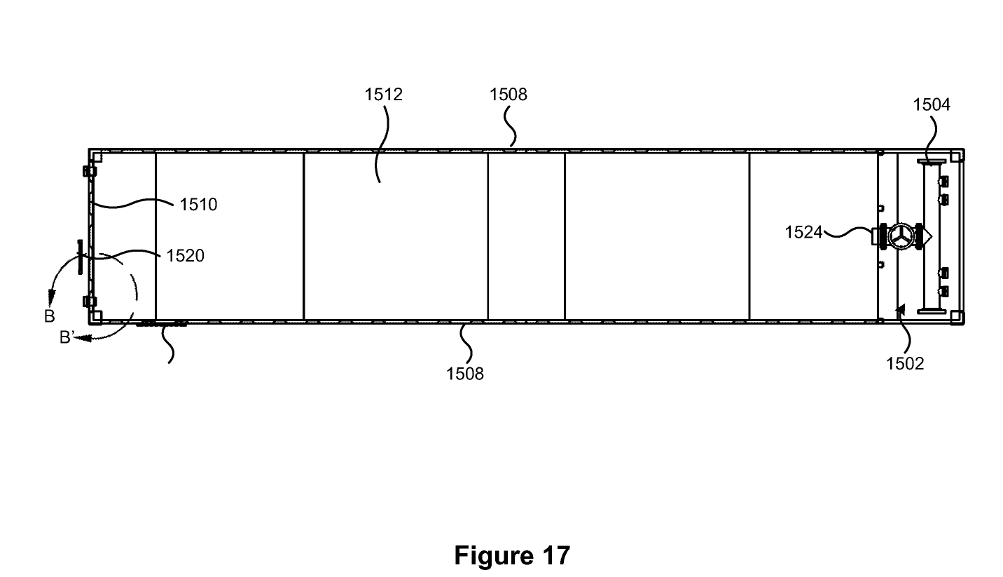

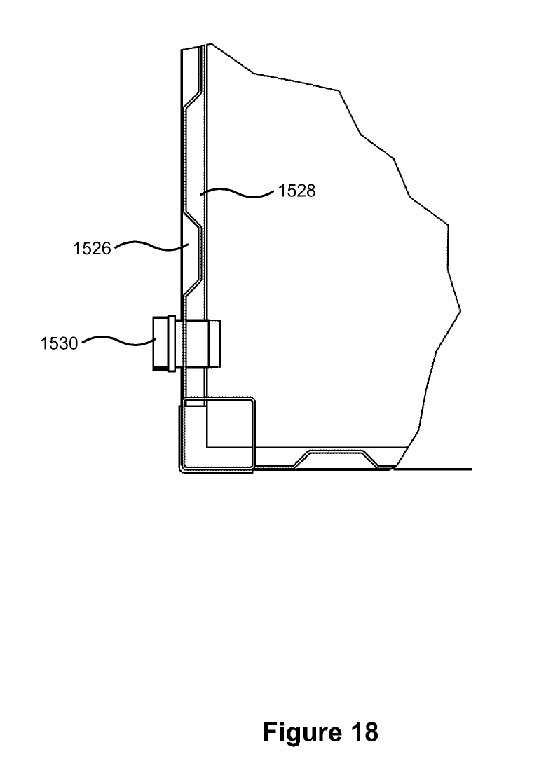

FIG. 15 is a perspective view of a specific implementation of a storage tank. FIG. 16 is a side view of the storage tank of FIG. 15. FIG. 17 is a top view along line A-A′ in FIG. 16. FIG. 18 is detailed view along line B-B′ in FIG. 17. The storage tank 1500 is similar to the storage tank 1400 described above. The storage tank 1500 may have the dimensions of an intermodal container, such as a 40 foot container. The storage tank 1500 comprises a cutout section 1502 that allows a manifold 1504 to be housed within the exterior dimensions of the storage tank 1500. The manifold 1504 can be connected to a drain pipe or outlet 1524 of the storage tank so that the storage tank can be filled and or emptied.

The storage tank 1500 includes cast corners 1506 that provide the female portion of a twist lock. The storage tank 1500 may include exterior walls, including side walls 1508, front and back walls 1510 as well as top and bottom walls 1512. The side walls 1508 and front and back walls 1510 may be corrugated steel. The top and bottom walls 1512 may be flat steel. The walls may include one or more hatchways 1514, 1516 that can be sealed, for example by bolting a hatchway cover over the hatchway. The hatchways may be used for filling or emptying the storage tank, for providing access to the interior of the storage tank for inspection or repair, or for mounting one or more accessories such as a heater or mixer.

The storage tank 1500 may have an external vent pipe 1518 and ladder 1520. The vent pipe 1518 and ladder 1520 may be removeably attached or attached on site, so that the exterior dimensions of the storage tank 1500 still meet the intermodal container dimensions. The storage tank 1500 may also include one or more vents, pipes or sealable openings 1530 that can provide flexibility in the various possible uses of the storage tank 1500.

The storage tank 1500 includes cast corners 1506 that can be used to secure the storage tank 1500 in place on site or during transportation, or alternatively can provide lift points for moving the storage tank 1500. Additionally, the storage tank 1500 may include one or more pairs of recesses 1522 in a bottom frame of the storage tank 1500 that can be used to lift the container with a fork lift.

The storage tank 1500 may be provided with a double walled containment system as described above. As depicted in detail in FIG. 18, a first containment wall can be provided by the exterior walls 1526 of the storage container which can be seamlessly welded together. A secondary containment wall 1528 can be provided on the interior of the storage tank. If the storage tank 1500 is adapted from an existing intermodal container, the secondary containment wall may be inserted into the existing container. Alternatively, the secondary containment wall may be assembled inside the container, either as a storage tank is being fabricated, or when a container is being adapted to the storage tank.

The storage tanks 1400 and 1500 described above can be used to hold liquids, solids or sludge. Although the storage tanks described above can carry liquids, solids or sludge they are primarily designed for carrying liquids, as the walls are not sloped, and as such would make emptying solids, such as suda ash, difficult. As described further below, a storage tank may be designed similar to those described above, however for primarily carrying solids, such as soda ash, powdered chemicals or other bulk solids. Similar to the storage tanks described above, the storage tanks described below can be easily converted to store solids and or liquids or other products. Further, the storage tanks described below can be used to transport products such as palletized products to a destination, and then converted to a storage tank to store solids such as chemicals or other solids at the destination.

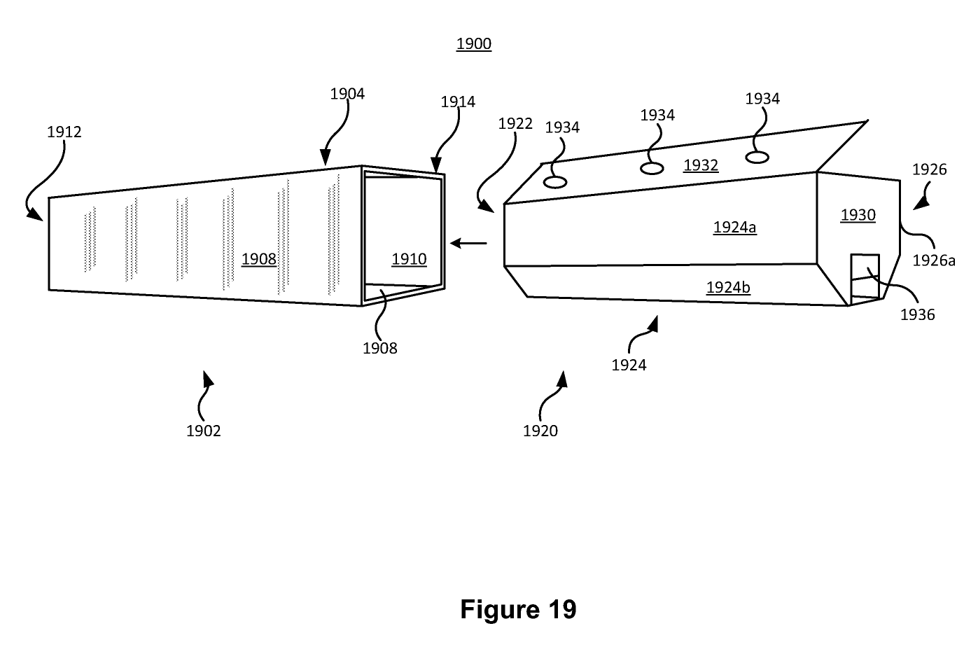

FIG. 19 depicts a further illustrative storage tank. The storage tank 1900 may comprise an outer container 1902 conforming to standard intermodal containers. For example, the exterior dimensions may have a height of 8′6″ a width of 8′ and a length of 19′10½″. It will be appreciated that the outer container 1902 may conform to other standard dimensions such as 40 foot containers, 40 foot high-cube containers or 45 foot high-cube containers.

The outer container 1902 may have a top wall 1904, a bottom wall 1906, two side walls 1908, 1910 and a back wall 1912. Although not depicted in FIG. 19, the outer container 1902 may further comprise a door or set of doors located at a front end 1914 of the container. The door or doors provide access to an interior of the outer container in order to allow loading and unloading of the outer container. The top wall 1904 may be hinged to one of the side walls 1908, 1910 allowing the top wall 1904 to be moved between an open position, in which the interior of the container 1902 is accessible, and a closed position, in which the interior is inaccessible from the top of the container.

The outer container may be fabricated so that it can be sealed. The side walls 1908, 1910, the back wall 1912 and the bottom wall 1906 may be welded together with a continuous weld, or sealed in other ways such as with epoxy or seals. The hinged top wall 1904 may be sealed using a gasket or similar seal that is compressed by the top wall when it is in the closed position. The outer container may further comprise a front flange that may provide a gasket or seal that is compressed when the door or doors of the container or closed.

As described above, the outer container 1902 may comprise two openings, namely the top opening when the hinged top wall 1904 is in the open position, and the front opening when the door or doors are open.

The storage tank 1900 further comprises an interior container 1920. The interior container 1920 may be fabricated as an insert that can be slid into the interior of the outer container 1902. The interior container 1920 comprises a back wall 1922, side walls 1924,1926 each comprising a vertical section 1924a, 1926a and a sloped portion 1924b, 1926b. The interior container 1920 further comprises a bottom wall 1928, a front wall 1930 and a top wall 1932. The back wall 1922, side walls 1924, 1926 and the front wall 1930 may be fabricated from metal that is welded together to seal the interior container. The top wall 1932 may be made of metal or may be made from a flexible material that can be drawn down towards the material in the interior of the interior container 1920. Regardless of what the top wall is made of, it may contain one or more manways 1934 or hatches that can be used when filling the interior container 1920. The manways 1934 may include an extendible shroud (not shown) that can be extended when filling the interior container to limit dust or other material from escaping when the interior container is being filled. Further, the top wall of the interior container may be hinged to one of the side walls 1924, 1926 in a similar fashion as the top wall of the exterior container to allow loading and unloading of the interior container.

The front wall 1930 includes a moveable hatch or door 1936 that can be opened or closed. When the hatch or door 1936 is in the open position, material can be emptied from the interior container may raising a back end of the container.

The storage tank 1900 may be used to store and/or transport various goods and materials. For example, the interior container may be used to transport palletized goods to a destination. The palletized goods can be loaded and/or unloaded through the open top wall. As will be appreciated a standard pallet may be approximately 4′×4′ in dimension. In an illustrative embodiment, the bottom wall is 4 feet wide to allow pallets of goods to be loaded into the bottom of the interior container 1920. The sidewalls are sized such that the vertical sections 1924a, 1926a begin at an expected height of the pallets so that a second row of pallets, two pallets wide, can be received on top of the lower level of pallets placed on the bottom wall of the interior container.

The interior container 1920 may further be used to store and/or transport bulk goods, such as chemical powders, or other bulk solids. The chemical powders or bulk solids may be loaded into the interior container through the manways 1934 or through the open top wall. If the top wall is made of a flexible material, a vacuum may be placed on the interior volume to draw the flexible material towards the material being stored. This may be advantageous to reduce moisture or air from interacting or reacting with the stored material. The bulk solids may be emptied from the interior container using the hatch on the front wall by tipping or dumping the container.

During transport or storage, both the interior container 1920 and the outer container 1902 may be sealed. The combination of the sealable interior container 1920 and the sealable outer container 1902 provide a double walled container that is suitable for transport liquids such as chemicals and/or oil or gas. Further the flexibility in loading and unloading the interior container allows the storage tank to be used to transport material to a destination, store different material at the destination, and transport different still material from the destination.

For example, the storage tank could be used to transport machine parts or other goods to a destination such as an oil well site. Once on site and unloaded, the storage tank could be used to store goods, including solids, liquids or sludge, at the destination or transport waste from the destination.

Additionally, the interior container 1920 may be sized so that, when the top wall is opened, or possibly removed, another interior container can be received within it. This stacking arrangement of the interior containers allows multiple interior containers to be transported to a destination, while a plurality of outer containers, that will eventually be used with an interior container, are used to transport goods to the destination as a typical container. Once at the destination, the outer containers can be unloaded and the interior containers unstacked. The interior containers may then be slid into the outer containers to provide storage tanks as described above. The outer container allows the storage tank to be moved and handled easily.

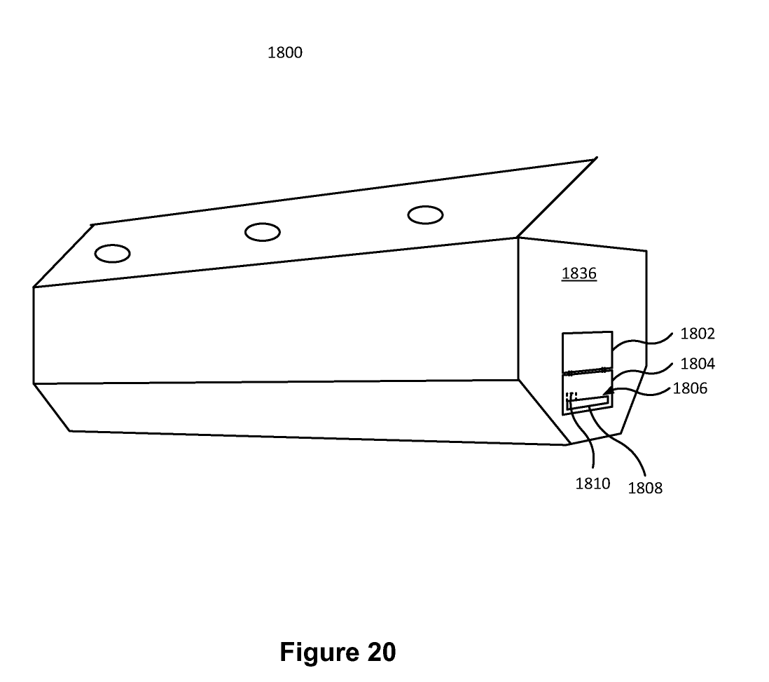

FIG. 20 depicts a further illustrative interior container. The interior container 2000 may be used on place of interior container 1920 described above. The interior container 2000 is substantially similar to the interior container 1920 and as such only the differences will be described in further detail. Instead of the hatch 1936 of the front wall for emptying the interior container 1920, the front wall 2036 of the interior container may comprise an opening 2002 and a sealable covering 2004. The sealable covering may be hinged to allow the sealable covering 2004 to be swung out of the way of the opening 2002, allowing the interior container to be emptied.

The sealable covering 2004 may be a solid covering or may be provided with a motorized auger 2006 for removing the material stored in the interior container. The auger includes an auger drive 2008 that is located inside the interior container. The auger may include a pipe adapter attachment to allow pneumatic transfer of discharged material at the discharge point of the auger. The auger 2008 may further comprise a drive motor 2010 located on the outside of the interior container. The auger may be mounted to the covering plate so that the interior container can be emptied while the opening is sealed by the covering. The covering may be opened with the auger attached to allow the interior container to be emptied through the opening. The auger may have a removable cover to cover the auger when not in use. For example, the auger could be covered if the interior container is to be filled with a liquid or sludge.

If the sealable covering includes an auger, the front wall, or a portion of the front wall may be recessed from the front of the storage tank to allow the drive motor of the auger to fit within the outer container when the sealable cover is closed, allowing doors of the outer container to be closed and sealed during transport.

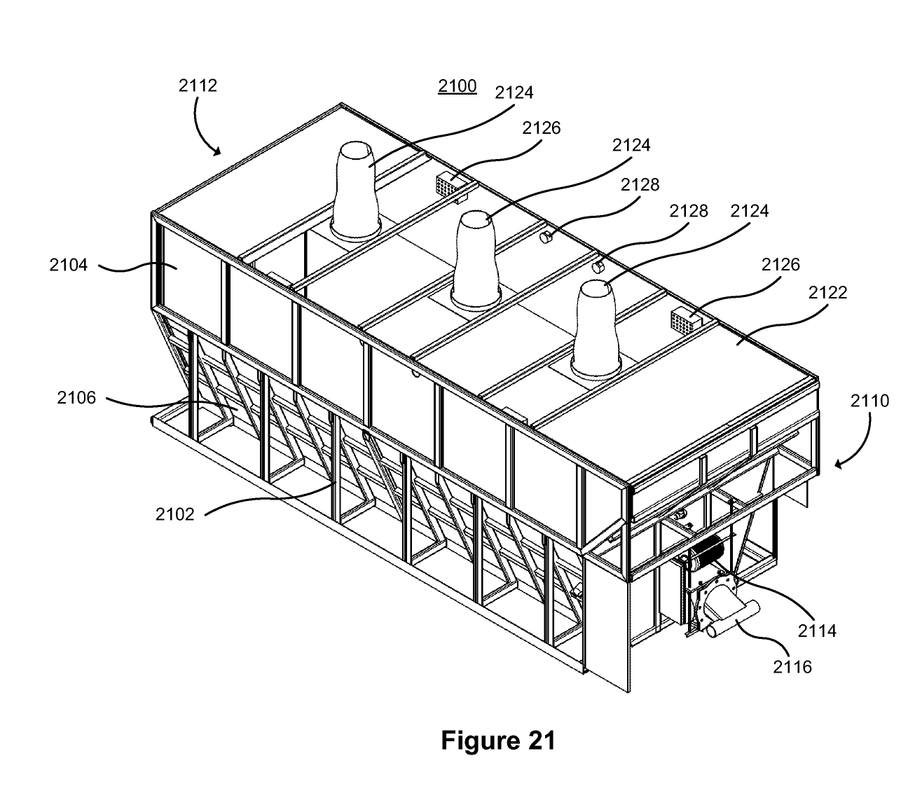

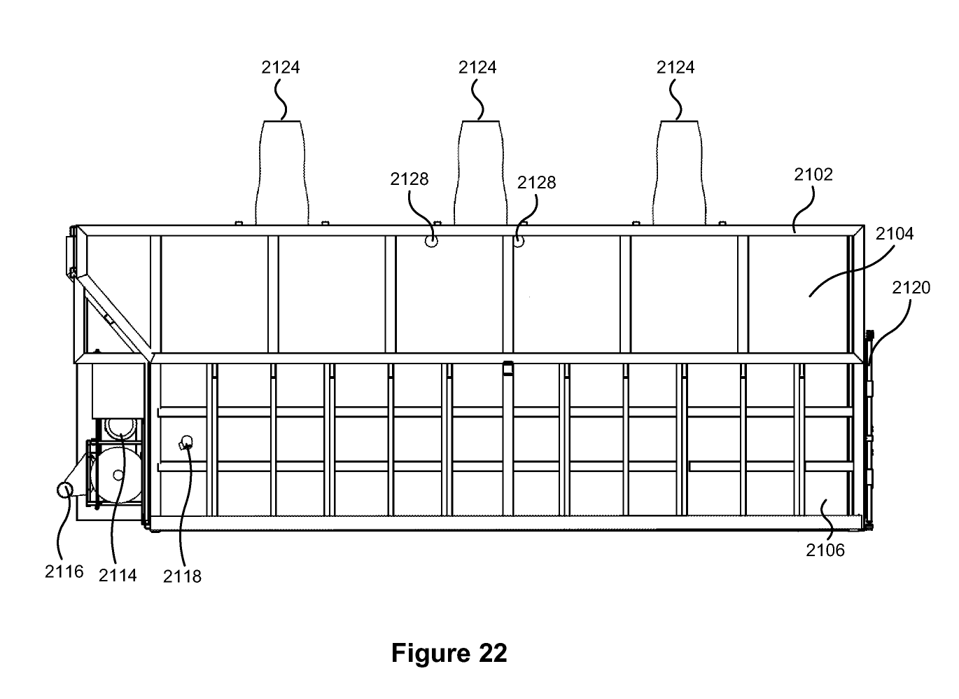

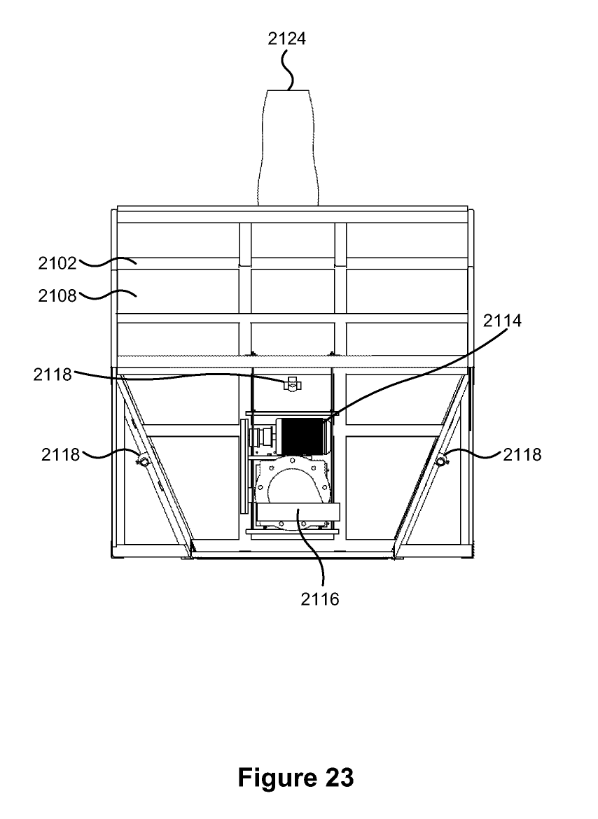

FIG. 21 depicts a further illustrative interior container. FIG. 22 is a side view of the interior container. FIG. 23 is a front view of the interior of the container. The interior container 2100 may be used on place of interior container 1920 or 2000 described above. The interior container 2100 comprises a frame 2102, which may be fabricated from tubular steel or similar materials that provide sufficient strength to the frame. Interior walls 2104, 1206 and a floor (not visible in Figures) can be affixed to the interior of the frame 2102. The interior walls 1204, 1206 and floor can be provided by a single piece of steel that is bent in order to fit the frame. The interior walls include sloped walls 2106 on the lower portion of the interior container 2100 that descend at an angle towards the interior of the container 2100. The sloped walls 2106 on each side of the container may be joined to a floor panel or alternatively may meet each other in the middle of the container 2100. The walls may include vertical walls 2104 that extend from the tops of the sloped walls 1206 to the top of the container frame 2102. Front panels 2108 and back panels (not visible in Figures) can be attached to the side walls in order to provide a substantially sealed container for holding material, such as for example soda ash.

The front 2110 of the interior container may include an auger motor 2114, or other means for emptying the container, and pipe connector 2116 for transferring materials out of the container. The walls of the interior container may include one or more nozzles 2118 that allow liquid, or air, to be injected into the interior container, which may be useful in various applications and provides flexibility to the interior container. The back 2112 of the interior container 2100 may be solid or may have an opening, sealable by doors 2120, that can be used for quickly dumping the material from the interior of the storage tank 2100.

The top of the interior container 2100 may be covered with panels 2122, or may be open. The interior container 2100 is depicted with a plurality of the top panels removed to more clearly illustrate the interior of the container 2100. The interior container 2100 may include one or more shrouds 2124 that can be extended, or removed. The shrouds 2124 can be used to limit the amount of dust and particles that escape during filling of the interior container 2100.

The interior container 2100 may include various components depending upon the anticipated application of the container 2100. For example the interior of the container 2100 may include one or more containers 2126 for holding a desiccating agent. The interior container 2100 may further include one or more air vents 2128 so that the interior container does not provide a hermetic seal.

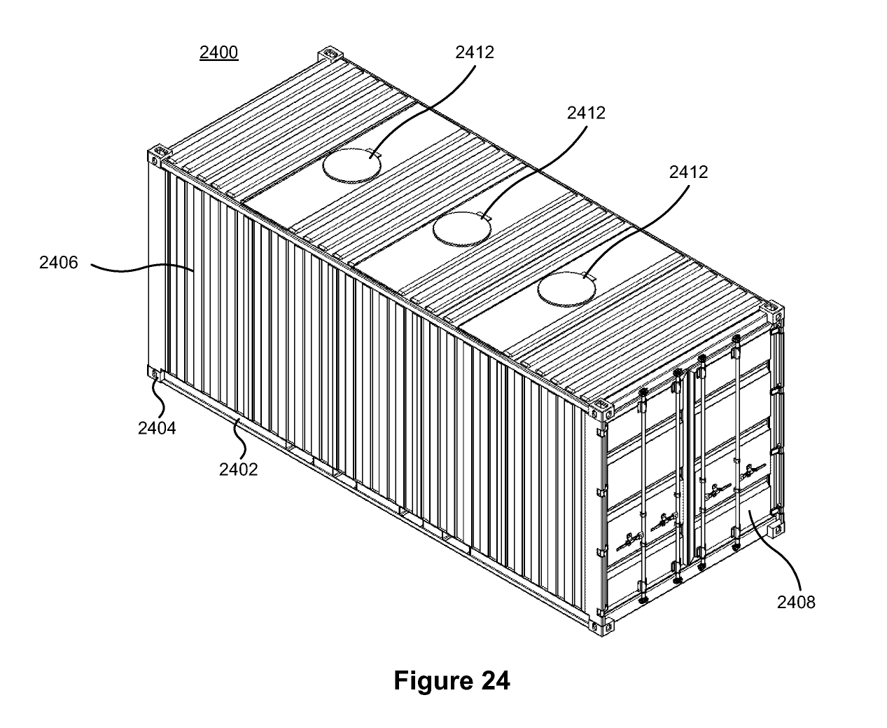

FIG. 24 is a perspective view of a back of an exterior container 2400. The exterior container 2400 may be receive the interior container 2100. The Exterior container may be modified from an existing intermodal container or may be fabricated incorporating the components described. The exterior container 2400 includes a frame 2402 and corner castings 2104. Exterior walls 2106 may be attached to the frame 2402. The exterior container 240o may include full-sized doors 2408 at a back of the exterior container 2400. The full-size doors 2408 allow the interior container 2100 to be slid into and out of the exterior container 2400. Additionally, the full sized doors may be opened in order to allow the sealable doors 2120 of the interior container 2100 to be opened and the contents of the interior container 2100 dumped. The exterior container 240o may further include a front panel that comprises a partial lower door 2410. When the partial lower door 2410 is opened it allows access to the pipe connector 2116 and allows the material of the interior container to be emptied. The exterior container 2400 further includes a plurality of hatch openings 2412. The hatch openings 2412 can be opened, and the shrouds 2124 extended to facilitate the filing of the interior container 2100.

The storage tanks described above provide various functionality for storing liquids, solids and sludge. The storage tanks may incorporate casted corners for twist lock mechanisms. The storage tanks described above may be adapted from existing intermodal containers or may be fabricated specifically for a particular purpose or application.

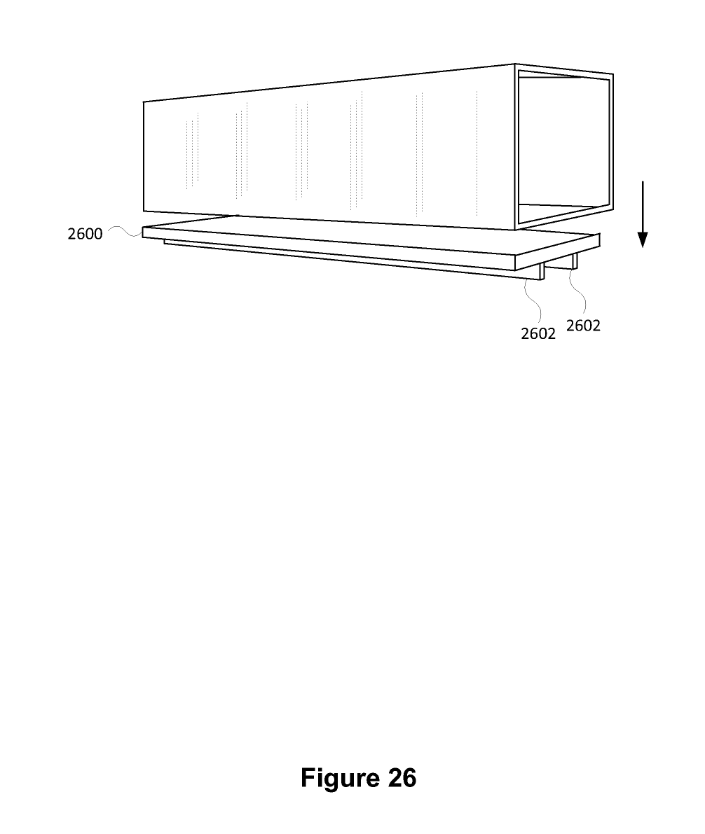

FIG. 26 depicts an illustrative container adapter 260o. The container adapter 260o can be coupled to the outer container of a storage tank and provides rails 2602, and possibly rollers that allow the storage tank and adapter to be rolled on and off from an appropriate truck. The adapter 2600 and roll-on roll-off truck may be used to empty a storage tank by tilting the container so that the material exits the door in the front wall.

While the present technology has been described in terms of specific implementations and configurations, further modifications, variations, modifications and refinements may be made without departing from the inventive concepts presented herein. The scope of the exclusive right sought by the Applicant(s) is therefore intended to be limited solely by the appended claims.

What is claimed is:

1. An intermodal container modified for storing liquid, sludge or solid, the modified intermodal container comprising:
a container comprising a floor and a roof sealingly joined by opposing side walls and opposing end walls, the container defining an interior space for storing the liquid, sludge or solid, wherein
the floor, roof, opposing side walls and opposing end walls being made of a rigid material, and
at least one of the opposing end walls being removably attached; and
a drain bottom inserted into the interior space, the drain bottom having an open end for receiving the liquid, sludge or solid and a tapered end connected to a drain hole through a pipe assembly, wherein the drain hole is located on the container.

2. The intermodal container according to claim 1, wherein the container further comprising a flange for removably attaching the at least one of the opposing end walls.

3. The intermodal container according to claim 2, wherein the at least one of the opposing end walls is removably attached to the flange using bolts.

4. The intermodal container according to claim 2, wherein a gasket is inserted between the at least one of the opposing end walls and the flange.

5. The intermodal container according to claim 1, further comprising a manway on at least one of the floor, roof, opposing side walls and opposing end walls.

6. The intermodal container according to claim 5, wherein the manway comprises a heating coil, a propeller mixer, or a nozzle mixer, or any combination thereof.

7. The intermodal container according to claim 1, further comprising a containment wall inserted into the interior space.

8. The intermodal container according to claim 7, wherein a seal is inserted between an edge of the open end of the drain bottom and the containment wall.

9. The intermodal container according to claim 1, wherein a seal is inserted between an edge of the open end of the drain bottom and the container.

10. The intermodal container according to claim 1, wherein the drain bottom is perforated.

11. The intermodal container according to claim 1, wherein the rigid material is steel.

12. The intermodal container according to claim 1, wherein the floor, roof, opposing side walls and opposing end walls are sealing joined by continuous weld.

13. The intermodal container according to claim 1, wherein the container being configured for vertical orientation.

14. A method of creating a intermodal container modified for storing liquid, sludge or solid, the method comprising:
providing a intermodal container having a floor made of a rigid material and the intermodal container being hermetically sealed;
inserting a drain bottom into an interior space of the intermodal container through an access door located at an end of the intermodal container;
connecting a tapered end of the drain bottom to a drain hole through a pipe assembly; and
removably attaching an end wall to the end of the intermodal container having the access door.

15. The method according to claim 14, further comprising installing the pipe assembly to the drain hole.

16. The method according to claim 14, further comprising attaching a flange to the end of the intermodal container having the access door.

17. The method according to claim 16, wherein the end wall is removably attached to the flange.

18. The method according to claim 17, further comprising inserting a gasket between the flange and the end wall.

19. The method according to claim 14, further comprising inserting a containment wall into the interior space of the intermodal container.

20. The method according to claim 14, further comprising removing the access door.

21. A portable storage tank comprising:
an outer sealable container conforming to an ISO intermodal container standard including at least one sealable door; and
an inner sealable container sized to be fully received within the outer container including at least one sealable opening through which the inner sealable container can be emptied.

22. The portable storage tank of claim 21, wherein the outer sealable container includes a sealable top wall hinged to the outer container a moveable between an open position in which an interior of the outer container is accessible, and a closed position in which the interior of the outer container is sealed.

23. The portable storage tank of claim 22, wherein the inner sealable container includes a sealable top wall hinged to the inner container a moveable between an open position in which an interior of the inner container is accessible, and a closed position in which the interior of the inner container is sealed.

24. The portable storage tank of claim 23, wherein the sealable top wall of the inner container further comprises one or more sealable manways.

25. The portable storage tank of claim 21 wherein the inner container includes a sealable covering of the at least one sealable opening.

26. The portable storage tank of claim 25, wherein the sealable covering includes an auger for use in removing material from the interior of the inner container.
